(19) United States
(12) Patent Application Publication
(10) Pub. No.: US 2010/0322083 A1
(43) Pub. Date: Dec. 23, 2010

(54) DETECTION AND REMOVAL OF ROUTING LOOPS IN A MOBILE INTERNET PROTOCOL NETWORK

(75) Inventor: Zu Qiang, Kirkland (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET L M ERICSSON (PUBL), Stockholm (SE)

(21) Appl. No.: 12/792,449

(22) Filed: Jun. 2, 2010

Related U.S. Application Data
(60) Provisional application No. 61/218,654, filed on Jun. 19, 2009.

(51) Int. Cl. H04L 12/26

(52) U.S. Cl. 370/248

(57) ABSTRACT

A method and a node are provided to detect routing loops in mobile Internet Protocol networks. A legitimate mobile node may register at a home agent by sending a binding message carrying a home address and a care-of address. The home agent stores the addresses in a binding cache entry. It is possible for a malicious node to send a binding message to one HA, resulting in a HoA being assigned by the HA. Then the malicious node may use this HoA as a CoA for registration at another HA. If the malicious MN uses the HoA assigned by the second HA as a CoA and updates the binding at the first HA, a routing loop is created. The present invention verifies the presence of a routing loop responsive to the receipt of the binding message. If a routing loop is detected, the binding cache entry is deleted.

### PRIORITY STATEMENT UNDER 35 U.S.C. S.119(e) & 37 C.F.R. S.1.78

This non-provisional patent application claims priority based upon the prior U.S. provisional patent application entitled “ROUTING LOOP DETECTION FUNCTION”, application No. 61/218,654, filed Jun. 19, 2009, in the name of Zu Qiang. The provisional patent application is incorporated herein by reference.

### TECHNICAL FIELD

The present invention relates generally to the field of communications and, more specifically, to a method and a node for detecting and removing routing loops in a mobile internet protocol network.

### BACKGROUND

A protocol for allowing a mobile node (MN) to remain reachable while moving around the Internet is specified in Request For Comments (RFC) 3775 “Mobility Support in IPv6”, published by the Internet Engineering Task Force (IETF). Per this and similar mobile IP (MIP) specifications, home agents (HA) are responsible for the registration of MNs in their home network. The HAs intercept packets destined for the MNs and tunnel these packets toward care-of addresses (CoA) assigned to the MNs by foreign agents (FA) in visited networks.

An IPv6 address has a length of 128 bits and comprises two main elements. A first element, which is 64-bit long, is known as a network prefix and constitutes a most significant part of the address. A second element, also 64-bit long, is known as an interface identifier (IID) or as a host part and constitutes a least significant part of the address. The HoA and the CoA may be IPv6 addresses and, as such, may both comprise a network prefix and an interface identifier. Mobile IP is used to support mobility in 3^{rd} generation partnership project (3GPP) specifications. According to the 3GPP specification Technical Specification (TS) 23.401, v9.1.0 (2009-06), in 3GPP implementations of Mobile IP, when assigning MNs with HoAs, the HA generally assigns a distinct network prefix, called home network prefix (HNP), for each of its MNs. An IID is also assigned to each MN, thereby providing the MN with a complete IPv6 address. In 3GPP implementations, a single MN may be distinguished on the sole basis of the HNP within its HoA, regardless of its IID, because the prefix is globally unique.

While the RFC 3375 is specified for internet protocol (IP) version 6 (IPv6), it is also possible to use MIP technology for so-called dual stack mobile IPv6 (DSMIPv6) mobile nodes. The Internet draft “Mobile IPv6 support for dual stack Hosts and Routers (DSMIPv6)/draft-ietf-mext-nemo-v4traversal”, also published by the IETF, allows the MN to use an IP version 4 (IPv4) address as a CoA for a registration under Mobile IP version 6 (MIPv6).

Problems may arise when a malicious MN violates the trust that is normally established between the MN and its HA. The problem is described in Internet draft “Mobile IPv6 Residual Threats/draft-haddad-mext-mip6-residual-threats-01” published by the IETF. When there are multiple HAs supported in a mobile network, it is possible for a malicious MN to register a binding at one HA, resulting in a HoA being assigned by the HA. Then the malicious MN may use this HoA as a CoA for MIPv6 registration at another HA. If the malicious MN then uses the HoA assigned by the second HA as a CoA and updates the binding at the first HA, a routing loop is created. This problem is described in “Mobile IPv6 Residual Threats/draft-haddad-mext-mip6-residual-threats-01”, also published by the IETF. Furthermore the malicious MN may create routing loops among multiple HAs by using the same method described above.

If such a routing loop is created, a HA encapsulates any received packet which is sent to the malicious MN's HoA with a new IP header and sends it to the registered CoA which is belonging to another HA. The second HA then encapsulates again and forwards the packet further to another HA. Every time the packet is encapsulated and forwarded, the TTL is renewed. Therefore, the HAs cannot easily stop the looping.

The RFC 2473 “Generic Packet Tunneling in IPv6 Specification”, from the IETF, specifies a tunnel encapsulation limit. Using this limit, the looped packet may eventually be discarded as the HA can no longer encapsulate a packet that has reached this limit. However, this dropping of the looped packet leads to a flood of error messages as described in “Mobile IPv6 Residual Threats/draft-haddad-mext-mip6-residual-threats-01” published by the IETF. To make matters worse, while DSMIPv6 is effective in supporting MNs that comply with both IPv4 and IPv6, the tunnel encapsulation limit method is not applicable in the case of DSMIPv6 with an IPv4 CoA.

To prevent the routing loop from being created, the HA may verify that the registered CoA does not belong to an IP address pool of another HA. However, it is possible for a legitimate CoA to belong to any IP address pool, either internal or external, so this verification might lead to dropping legitimate packets. Also, for scalability reasons, verifying every CoA is not practical for the HA

### SUMMARY

It is therefore a broad object of this invention to provide a method and a node for detecting routing loops that may be setup, accidentally or for malicious reasons, between home agents.

A first aspect of the present invention is directed a method of detecting routing loops. The method is initiated at a first home agent (HA) when it receives, from a mobile node (MN), a binding update (BU) message. The BU message comprises a home address (HoA) and a care-of address (CoA). The first HA stores the HoA and the CoA in a binding cache entry (BCE) created by the first HA for the MN. The first HA sends the HoA and the CoA toward a routing loop detection function (RLDF). If the first HA receives, from the RLDF, a reply indicating that a routing loop between the first HA and a second HA has been detected, the BCE is deleted from the first HA.

A second aspect of the present invention is directed a variant of the above method of detecting routing loops. The RLDF updates a routing chain by storing the HoA as an element of the routing chain and by attaching the CoA as a next element of the routing chain. A routing loop may be detected in the RLDF; that will be the case when the HoA is equal to another CoA previously stored in another routing chain for the second HA while the CoA is equal to another HoA stored in the other routing chain

A third aspect of the present invention is directed to a routing loop detection function (RLDF) node. The RLDF node comprises an interface for communicating with a plurality of home agents (HA) over one or more communication links, a memory that stores a routing chaining table comprising one or more routing chains, each routing chain comprising at least one home address (HoA) linked to at least one care-of address (CoA), and a controller. The controller can read and write in the memory. The controller also controls the interface and communicates with the HAs therethrough. Also, the controller can receive from a first HA a first HoA and first CoA. The controller stores the first HoA and the first CoA in a first routing chain of the routing chaining table. It then detects a routing loop if the first HoA is equal to a second CoA present in a second routing chain for a second HA and if the first CoA is equal to a second HoA located in the second routing chain. If a routing loop is detected, the controller sends an indication toward the HA.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 shows steps of an exemplary method of detecting routing loops, as per some teachings of the present invention;

FIG. 2 shows a sequence diagram depicting exemplary steps of the method of the present invention; and

FIG. 3 shows an exemplary routing loop detection function node according to an aspect of the present invention.

### DETAILED DESCRIPTION

The innovative teachings of the present invention will be described with particular reference to various exemplary uses and aspects of the preferred embodiment. However, it should be understood that this embodiment provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the description of the figures, like numerals represent like elements of the invention.

The present invention provides a method and a node for detecting and curing routing loops that may be established, accidentally or out of malicious intent, from a third party, between home agents (HA). As a given HA receives a binding update (BU) message, either for the purpose of registering a mobile node (MN) or for the purpose of updating a previous registration, the BU message comprising a home address (HoA) of the MN and a care-of address (CoA) assigned to the MN, the given HA invokes a routing loop detection function (RLDF), which is a mechanism of the present invention. The RLDF stores the HoA and the CoA in a routing chain. The RLDF may have previously stored one or more existing routing chains in an internal routing chaining table, each routing chain comprising a HoA assigned by one of a plurality of HAs and a CoA corresponding to the HoA in the same routing chain. Each routing chain may comprise additional addresses. The RLDF searches for routing loops by considering the HoA and the CoA received from the given HA as well as previous addresses stored in the routing chaining table. In an exemplary embodiment, the RLDF detects a routing loop if the HoA is equal to another CoA previously stored in another routing chain for another HA and if the CoA is equal to another HoA stored in that other routing chain.

In the context of the present invention, a routing loop detection function (RLDF) may be implemented in an RLDF node; the RLDF node may be a stand-alone physical node, distinct from the HA, or a logical node sharing a common platform with the HA or with another node. The HA may act as a foreign agents for other mobile nodes, and may comprise other units, useful in an internet protocol (IP) network. The MN may comprise a mobile cellular telephone, a digital personal assistant, a laptop computer, an IP television apparatus, a gaming device, a server, and the like. The present invention may apply in the context of IP version 4 (IPv4) or IP version 6 (IPv6) networks.

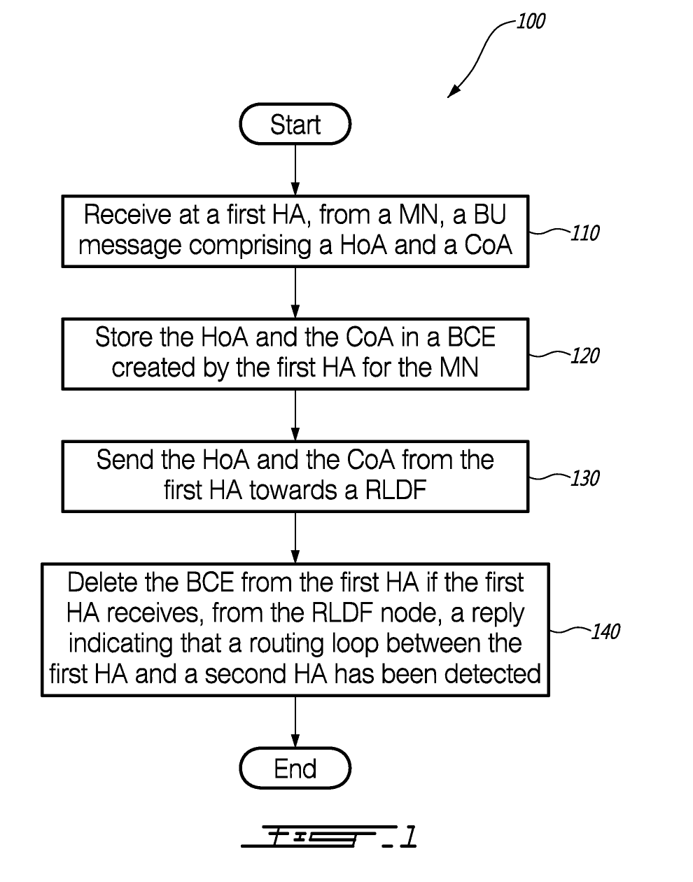

Reference is now made to the Drawings, in which FIG. 1 shows steps of an exemplary method of detecting routing loops, as per some teachings of the present invention. A sequence 100 may be implemented in a HA, this HA being different from prior art HAs because it has been modified per the teachings of the present invention. At step 110, a first HA receives a BU message from a MN. The BU message carries a HoA of the MN and a CoA assigned to the MN. At step 120, the first HA stores the HoA and the CoA in a binding cache entry (BCE) created at the first HA for registering the MN. The first HA then sends, at step 130, the HoA and the CoA toward a RLDF. If the first HA receives from the RLDF, at step 140, a reply indicating that a rooting loop has been detected between the first HA and a second HA, the first HA deletes the BCE.

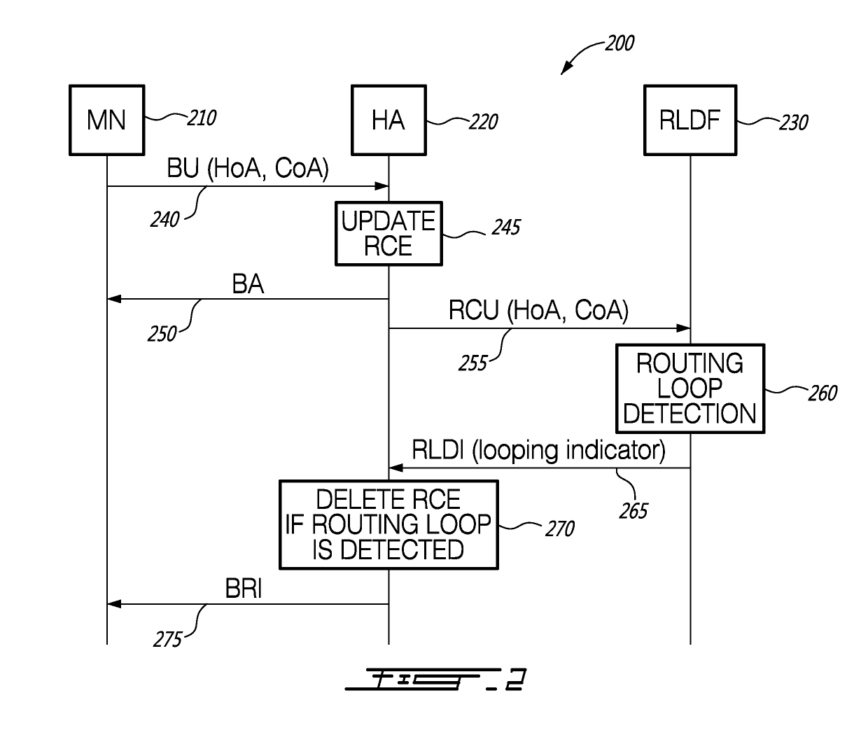

FIG. 2 shows a sequence diagram depicting exemplary steps of the method of the present invention. A mobile IP network 200 comprises a MN 210, an HA 220, and a RLDF node 230. Even though elements of the IP network 200 are shown as directly coupled in FIG. 2, the elements may be indirectly coupled and separated geographically. For example, access may be provided to the MN 210 by an access point (not shown) connected to a foreign agent (FA, not shown), the FA being connected toward the HA 220 via a plurality of gateways, bridges and routers (not shown). Though only the HA 220 is shown on FIG. 2, the RLDF node 230 is connected toward a plurality of HAs. The simplified coupling is shown in order to more clearly illustrate interworking between elements involved in the method of the present invention. Likewise, though many elements are not shown on FIG. 2, the shown nodes are those that are implicated in the exemplary steps of the method of the present invention.

A sequence starts at step 240 when the MN 210 sends a BU message toward the HA 220. The BU message carries a HoA of the MN 210 and a CoA, which has generally been assigned to the MN 210 by a local FA (not shown). As is well known in the art, the HoA and the CoA each comprises a network prefix and an interface identifier. When receiving the BU message of step 240, the HA 220 either creates or updates a BCE for the MN 210 at step 245. The BCE may for example be created if the BU message comprises a binding registration indication. The BCE may have been created earlier, for the MN 210, at the HA 220; that would be the case if a previous BU message has been received for the MN 210, with a same HoA and if the BU message of step 240, comprises an update indication indicating a movement (handoff) of the MN 210 into the present local FA. Regardless, the HoA and the CoA as received in the BU message are stored in the BCE for the MN 210. The HA 220 may send a binding acknowledgement (BA) message toward the MN 210 at step 250. The HA 220 also sends the HoA and the CoA, in a routing chaining update (RCU) message, toward the RLDF node 230, at step 255. The RLDF node 230 performs a routing loop detection algorithm at step 260. This algorithm may involve updating a routing chain at the RLDF node 230 node by storing the HoA as an element of the routing chain and by attaching the CoA as a next element of the chain. In some embodiments, the RLDF node 230 node detects a routing loop if the HoA is equal to another CoA previously stored in another routing chain for another HA and if the CoA is equal to another HoA stored in the routing chain of that other HA.

The RLDF node 230 may send toward the HA 220 a routing loop detection indicator (RLDI) message carrying a looping indicator, at step 265. The looping indicator may indicate that a routing loop was found between the HA 220 and another HA, or not. In some embodiments, the RLDF node 230 may silently end the sequence of FIG. 2, following step 260, if no routing loop is detected at step 260. If the HA 220 receives the RLDI message indicating that no routing loop was found, no action is taken, which is equivalent to the case where the RLDF node 230 refrains from sending any acknowledgement following step 260. If the looping indicator is received, showing that a routing loop was found between the HA 220 and another HA, the HA 220 deletes its BCE for the MN 210 at step 270. In that case, the HA 220 may send a binding revocation indicator (BRI) message toward the MN at step 275. In some embodiments, the RLDI message itself may be construed as an indication that a routing loop was detected. That would be the case in embodiments where the RLDF node 230 silently ends the sequence after step 260 if no routing loop is detected. In such cases, it is not necessary for the RLDI message to carry a specific indicator.

In more details, in the routing loop detection step 260, the following cases may apply:
a. If the HoA is not found as a CoA in any existing routing chain and the CoA is not found as a HoA in any existing routing chain, a new routing chain is created in the routing chaining table. On that routing chain, a first element of the row is an index set equal to the HoA. The HoA is chained with the CoA by placing the CoA as a next element, immediately attached to the HoA. There is no detection of a routing loop.
b. If the HoA is found but is not the last chained node in a given existing routing chain and if the CoA is not same as the HoA in that given routing chain, the chained CoA field is updated by overwriting it with the received CoA. There is no detection of a routing loop.
c. If the HoA is found as a chained node in one existing routing chain and the CoA is same as the HoA in the routing chain, then a routing loop is detected.
d. If the HoA is found as the last chained node in one existing routing chain and the CoA is not same as to another HoA in the same routing chain, the received CoA is added as another chained node in the same routing chain. There is no detection of a routing loop.

As an example of a looping detection under ‘c’ above, a routing chain may contain three addresses: IP1 linked to IP2, which is further linked to IP3. IP1 is a HoA1 and IP2 is a CoA1 for a first binding received in a first BU. At the same time, IP2 is a HoA2 and IP3 is a CoA2 for a second binding. These links have been previously stored without any loop detection. If a new BU is received with HoA3 equal to CoA2 (IP3), and CoA3 equal to HoA1 (IP1), a looping has been detected. Likewise, if the new BU carries HoA3 equal to CoA2 (IP3), and CoA3 equal to HoA2 (IP2), another looping case has been detected.

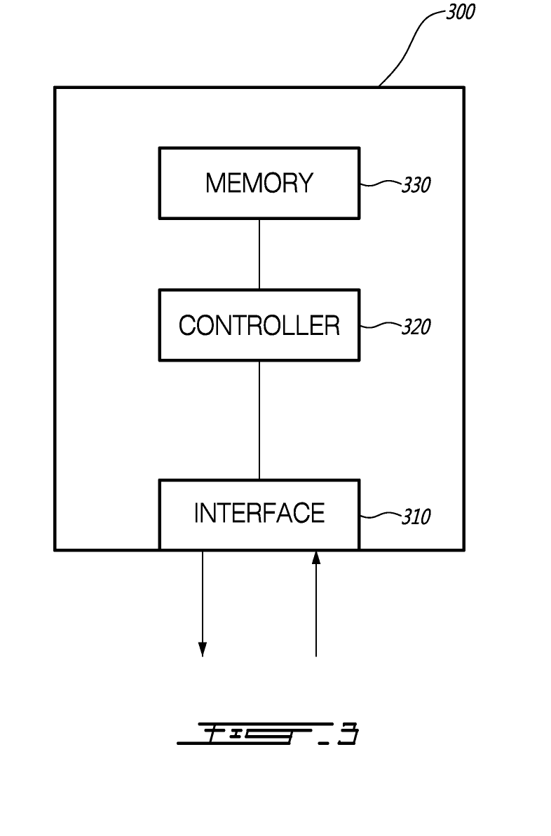

An exemplary construction of an RLDF node will now be described by reference to FIG. 3, which shows an exemplary routing loop detection function node according to an aspect of the present invention. An RLDF node 300 comprises an interface 310, a controller 320 and a memory 330. The memory 330 may be a volatile memory, or may alternatively be a non-volatile memory, or persistent memory, that can be electrically erased and reprogrammed and that may be implemented, for example, as a flash memory or as a data storage module. The memory 330 is configured to store a routing chaining table comprising one or more routing chains, each routing chain comprising at least one HoA linked to at least one CoA. The controller 320 may be any commercially available, general purpose processor, or may be specifically designed for operation in the RLDF node 300. The controller 320 may be operable to execute processes related to the present invention in addition to numerous other processes. Specifically, the controller 320 reads and writes in the memory, controls the interface, and communicates with HAs therethrough. The interface 310 may be implemented as one single device or as distinct devices for receiving and sending signaling, messages and data over one or more communication links. The RLDF node 300 is connected toward a plurality of HAs; means for connecting the RLDF node 300 toward these and other network elements may vary as, for example, connection toward one HA might be on an Ethernet link while connection toward another HA might be on an asynchronous transfer mode (ATM) link. Therefore, the interface 310 may comprise a plurality of devices for connecting on a plurality of links of different types. Only one generic interface 310 is illustrated for ease of presentation of the present invention. The RLDF node 300 may further act as a gateway or a router and may thus comprise many more components, as is well-known in the art.

In operation, the controller 320 of the RLDF node 300 receives from a first HA a pair comprising a first HoA and a first CoA. The controller 320 stores the received pair in a first routing chain of the routing chaining table, in the memory 330. In some embodiments, storing the first HoA and the first CoA in the routing chaining table may comprise storing the first HoA as an element of the routing chain and attaching the first CoA as a next element of the routing chain. The controller 320 then searches for a loop in the routing chaining table. In some embodiments, a routing loop is detected if the first HoA is equal to another CoA previously stored in any routing chain and if the first CoA is equal to another HoA located earlier in the same routing chain. Alternatively, the controller may detect a routing loop if the first HoA is equal to a second CoA present in a second routing chain for a second HA and if the first CoA is equal to a second HoA also located in the second routing chain. The controller 320 may send a result of the search toward the first HA. In some embodiments, a result is only sent if a routing loop was found. In other embodiments, a result is sent each time a routing loop verification is made for a given HoA-CoA pair, in which case the result indicates whether or not a routing loop was detected.

In addition to the features described in relation to FIG. 3, the RLDF node 300 may be capable of performing the features of the various embodiments of the RLDF presented in FIGS. 1 and 2.

Although several aspects of the preferred embodiment of the method and of the RLDF node of the present invention have been illustrated in the accompanying Drawings and described in the foregoing Detailed Description, it will be understood that the invention is not limited to the embodiments disclosed, but is capable of numerous rearrangements, modifications and substitutions without departing from the teachings of the invention as set forth and defined by the following claims.

1. A method of detecting routing loops, the method comprising the steps of:
receiving at a first home agent (HA), from a mobile node (MN), a binding update (BU) message comprising a home address (HoA) and a care-of address (CoA);
storing the HoA and the CoA in a binding cache entry (BCE) created by the first HA for the MN;
sending the HoA and the CoA from the first HA toward a routing loop detection function (RLDF); and
deleting the BCE from the first HA if the first HA receives, from the RLDF, a reply indicating that a routing loop between the first HA and a second HA has been detected.

2. The method of claim 1, wherein:
the BU message comprises a binding registration indication; and
the BCE is created by the first HA upon receipt of the BU message.

3. The method of claim 1, wherein:
the BU message comprises an update indication;
the BCE is pre-existing in the first HA before receiving the BU message; and
the step of storing comprises updating the BCE with the HoA and the CoA.

4. The method of claim 1, further comprising the step of:
receiving at the first HA, from the RLDF, a reply indicating that no routing loop has been detected.

5. The method of claim 1, further comprising the step of:
responsive to the BU message, sending from the first HA, toward the MN, a binding acknowledgement (BA) message.

6. The method of claim 1, further comprising the step of:
responsive to the deletion of the BCE, sending from the first HA, toward the MN, a binding revocation indicator (BRI) message.

7. The method of claim 1, further comprising the step of:
updating a routing chain at the RLDF by storing the HoA as an element of the routing chain and by attaching the CoA as a next element of the routing chain.

8. The method of claim 7, wherein:
the RLDF detects a routing loop if the HoA is equal to another CoA previously stored in another routing chain for the second HA and if the CoA is equal to another HoA stored in the other routing chain.

9. The method of claim 1, wherein:
the HoA comprises a network prefix and an interface identifier.

10. A routing loop detection function (RLDF) node, comprising:
an interface configured to communicate with a plurality of home agents (HA) over one or more communication links;
a memory configured to store a routing chaining table comprising one or more routing chains, each routing chain comprising at least one home address (HoA) linked to at least one care-of address (CoA); and
a controller configured to read and write in the memory, to control the interface and to communicate with the HAs therethrough, the controller further configured to:
receive from a first HA a first HoA and a first CoA,
store the first HoA and the first CoA in a first routing chain,
detect a routing loop if the first HoA is equal to a second CoA present in a second routing chain for a second HA and if the first CoA is equal to a second HoA located in the second routing chain, and
send toward the HA an indication if a routing loop is detected.

11. The RLDF node of claim 10, wherein:
the controller is further adapted to update the routing chain by storing the HoA as an element of the routing chain and by attaching the CoA as a next element of the routing chain.

12. The RLDF node of claim 10, wherein:
the controller is further adapted to unconditionally send toward the HA a result of the search, the result indicating whether or not a routing loop is detected.
